(19) United States
(12) Patent Application Publication
(10) Pub. No.: US 2015/0138753 A1
(43) Pub. Date: May 21, 2015

(54) LIGHT-SOURCE APPARATUS

(71) Applicant: OLYMPUS CORPORATION, Tokyo (JP)

(72) Inventor: Koichiro FURUTA, Tokyo (JP)

(73) Assignee: OLYMPUS CORPORATION, Tokyo (JP)

(21) Appl. No.: 14/567,212

(22) Filed: Dec. 11, 2014

Related U.S. Application Data
(63) Continuation of application No. PCT/JP2013/068214, filed on Jul. 3, 2013.

(30) Foreign Application Priority Data
Jul. 9, 2012 (JP) 2012-153231

(51) Int. Cl. F21K 99/00; F21V 13/04

(52) U.S. Cl. CPC F21K 9/56; F21V 13/04; F21Y 2101/025
USPC 362/84

(57) ABSTRACT

The optical-path configuration is made more compact and light is generated at high efficiency. Provided is a light-source apparatus including a light source that outputs monochromatic light; a wavelength conversion device that is disposed on an output optical axis of the light source and that generates light having a different color from that of the monochromatic light upon being irradiated with the monochromatic light; and a dichroic mirror that is disposed between the light source and the wavelength conversion device, that transmits the monochromatic light, and that, of the light generated at the wavelength conversion device, reflects back toward the wavelength conversion device light that has been scattered toward the light source so as to be parallel to the output optical axis.

### CROSS-REFERENCE TO RELATED APPLICATIONS

This is a continuation of International Application PCT/JP2013/068214, with an international filing date of Jul. 3, 2013, which is hereby incorporated by reference herein in its entirety. This application claims the benefit of Japanese Patent Application No. 2012-153231, filed on Jul. 9, 2012, the content of which is incorporated herein by reference.

### TECHNICAL FIELD

The present invention relates to a light-source apparatus.

### BACKGROUND ART

In the related art, there is a known light-source apparatus that generates light of a plurality of colors by using a light source that outputs monochromatic light, such as a semiconductor light source (for example, see Patent Literature 1). With Patent Literature 1, a blue laser diode (LD) is used as a light source, a rotating wheel that has a region that transmits blue light and regions that generate red and green fluorescence by using the blue light and that reflect this fluorescence is provided, and the blue light is guided in a separate optical path from the one in which the red light and green light are guided.

Because the light-source apparatus of Patent Literature 1 is separately provided with the optical path for guiding the blue light and the optical path for guiding the red light and green light, the size of the device is increased and the number of parts is increased. In addition, because the optical paths are folded multiple times by using mirrors, the light-guiding efficiency is low. Specifically, if the mirror angle with respect to the optical axis is shifted by θ, the shift in the angle of the optical axis of the reflected light becomes two-times greater, that is, 2θ. This shift in the optical-axis angle is accumulated each time the light is reflected by the mirrors. In addition, light is lost each time the light is reflected by the mirrors.

### CITATION LIST

### Patent Literature

### PTL 1 Publication of Japanese Patent No. 4711154

### SUMMARY OF THE INVENTION

The present invention provides a light-source apparatus provided with a light source that outputs monochromatic light; a wavelength conversion device that is disposed on the output optical axis of the light source and that generates light having a different color from that of the monochromatic light upon being irradiated with the monochromatic light; and a dichroic mirror that is disposed between the light source and the wavelength conversion device, that transmits the monochromatic light, and that, of the light generated at the wavelength conversion device, reflects back toward the wavelength conversion device light that has been scattered toward the light source so as to be parallel to the output optical axis.

### BRIEF DESCRIPTION OF DRAWINGS

FIG. 1 is a diagram showing the overall configuration of a light-source apparatus according to an embodiment of the present invention.

FIG. 2 is a diagram showing a modification of a wavelength conversion device provided in the light-source apparatus in FIG. 1.

FIG. 3 is a diagram showing another modification of the wavelength conversion device provided in the light-source apparatus in FIG. 1.

FIG. 4 is a diagram showing the overall configuration of a modification of the light-source apparatus in FIG. 1.

FIG. 5 is a diagram showing the overall configuration of another modification of the light-source apparatus in FIG. 1.

FIG. 6 is a diagram showing the overall configuration of yet another modification of the light-source apparatus in FIG. 1.

FIG. 7A is a front view of a rotating turret provided in the light-source apparatus according to the modification in FIG. 6.

FIG. 7B is a side view of the rotating turret in FIG. 7A.

FIG. 8 is a graph showing, for the light-source apparatus in FIG. 1, the spectral transmittance characteristic of the dichroic mirror and wavelength distributions of laser light output from the light source and fluorescence generated by the wavelength conversion device.

FIG. 9 is a graph showing, for the light-source apparatus in FIG. 5, the spectral transmittance characteristics of the two dichroic mirrors and wavelength distributions of the laser light and the fluorescence.

### DESCRIPTION OF EMBODIMENT

A light-source apparatus 1 according to an embodiment of the present invention will be described below with reference to the drawings.

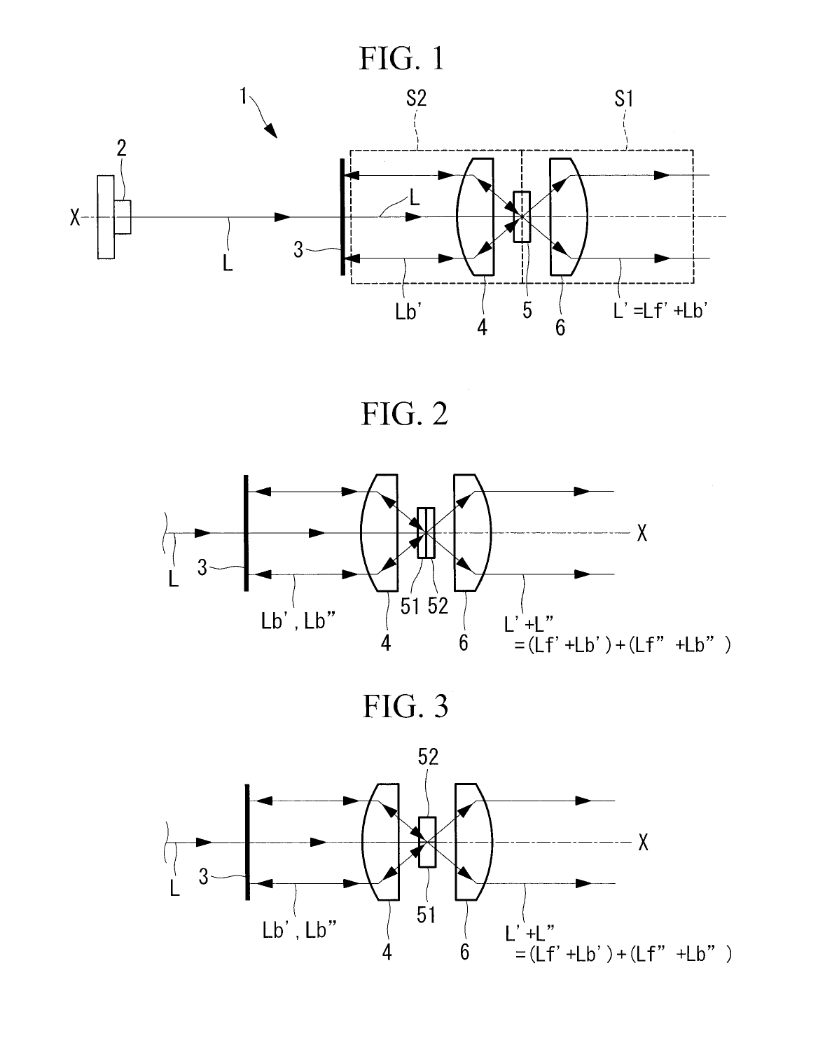

As shown in FIG. 1, the light-source apparatus 1 according to this embodiment is provided with a light source 2 that outputs monochromatic light and a dichroic mirror 3, a first collimating optical system 4, a wavelength conversion device 5, and a second collimating optical system 6 that are arranged in a row on an output optical axis X (hereinafter, also referred to simply as the optical axis X) of the light source 2.

The light source 2 is a semiconductor light source, a laser diode, or the like that outputs a high-directivity monochromatic beam. In this embodiment, the monochromatic beam is assumed to be blue laser light L having a wavelength of 450 nm. Although FIG. 1 shows the single light source 2, a plurality of light sources 2 that output the laser light L so as to be parallel to each other may be disposed in an array (for example, 2×2 or 3×3).

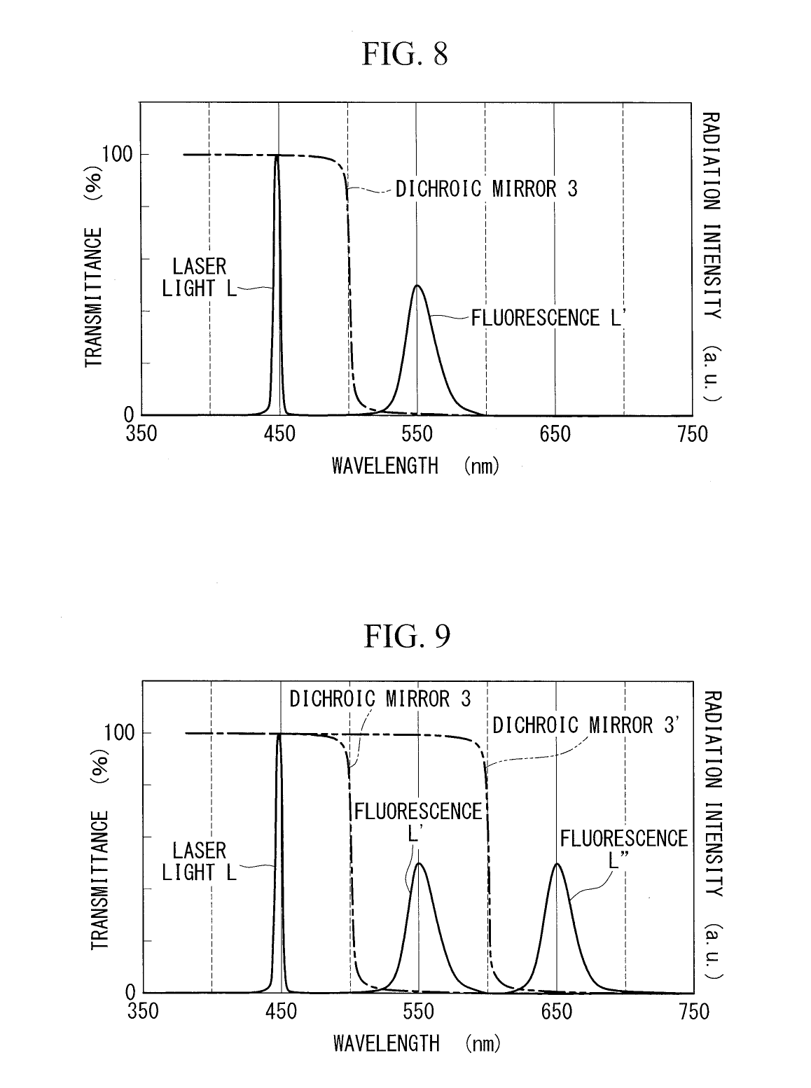

The dichroic mirror 3 is disposed perpendicular to the optical axis X and transmits the laser light L that has entered from the light source 2 along the optical axis X. In addition, the dichroic mirror 3 reflects, along the optical axis X, fluorescence Lb′ that has been scattered backward at the wavelength conversion device 5, as described later. In this embodiment, the dichroic mirror 3 is assumed to have the property that it transmits light having a wavelength equal to or less than 500 nm and reflects light having a wavelength longer than 500 nm. FIG. 8 shows the relationship assumed in this embodiment among the wavelength of the laser light L, the wavelength of fluorescence L′ (described later) generated by the wavelength conversion device 5, and the spectral transmittance characteristic of the dichroic mirror 3. The left vertical axis indicates the transmittance of the dichroic mirror 3, and the right vertical axis indicates the relative intensity of the laser light L and the fluorescence L′.

The first collimating optical system 4 is provided with a meniscus lens or a plano-convex lens that is placed with the convex surface thereof facing the light source 2. The meniscus lens or the plano-convex lens is disposed away from the dichroic mirror 3 and the wavelength conversion device 5. The first collimating optical system 4 converts the fluorescence L′ scattered backward at the wavelength conversion device 5 to collimated light and emits it toward the dichroic mirror 3. In addition, the first collimating optical system 4 focuses the fluorescence L′, which returns thereto by being reflected by the dichroic mirror 3, at the wavelength conversion device 5. Here, by placing a meniscus lens or a plano-convex lens so that the convex surface thereof faces the light source 2, as described above, it is possible to suppress spherical aberration. It is desirable that the first collimating optical system 4 be formed of a plurality of lenses in which the meniscus lens or the plano-convex lens, described above, is combined with another lens (not shown). By doing so, it is possible to further suppress spherical aberration.

The wavelength conversion device 5 is a device that emits light upon being irradiated with the laser light L (monochromatic light) from the light source 2 and contains, for example, fluorophores or quantum dots that are excited by the laser light L. In this embodiment, the wavelength conversion device 5 is assumed to be a fluorophore whose excitation wavelength band includes 450 nm, which is the wavelength of the laser light L, and that generates the fluorescence (light) L′ having a peak wavelength at 550 nm. The fluorescence L′ generated at the wavelength conversion device 5 is divided into fluorescence Lf′ that is scattered forward into a space S1 on the forward side of the optical axis X (the side away from the light source 2) and fluorescence Lb′ that is scattered backward into a space S2 on the rear side of the optical axis X (the same side as the light source 2). Of the fluorescence Lf′ and the fluorescence Lb′, the fluorescence Lf′ that has been scattered forward enters the second collimating optical system 6, and the fluorescence Lb′ that has been scattered backward enters the first collimating optical system 4.

The second collimating optical system 6 is provided with one meniscus lens or one plano-convex lens that is placed so that the convex surface thereof faces forward along the optical axis X. The meniscus lens or the plano-convex lens is disposed away from the wavelength conversion device 5. The second collimating optical system 6 converts the fluorescence L′ that has entered from the wavelength conversion device 5 to collimated light and emits it along the optical axis X. It is desirable that the second collimating optical system 6 be formed of a plurality of lenses in which the meniscus lens or the plano-convex lens described above is combined with another lens (not shown). By doing so, it is possible to further suppress spherical aberration.

Next, the operation of the thus-configured light-source apparatus 1 will be described.

With the light-source apparatus 1 according to this embodiment, the blue laser light L output from the light source 2 passes through the dichroic mirror 3 and enters the wavelength conversion device 5, thus generating the green fluorescence L′ at the wavelength conversion device 5. Of the generated fluorescence L′, the fluorescence Lf′ that has been scattered forward is externally output from the light-source apparatus 1 along the optical axis X after being converted to collimated light at the second collimating optical system 6.

On the other hand, the fluorescence Lb′ that has been scattered backward and travelled in the reverse direction along the optical axis X is reflected back by the dichroic mirror 3 after being converted to collimated light at the first collimating optical system 4 and is focused on the wavelength conversion device 5 by the first collimating optical system 4. Here, the light-emitting wavelength band and the excitation wavelength band of the wavelength conversion device 5 overlap with each other only slightly or not at all. Therefore, the fluorescence Lb′ focused on the wavelength conversion device 5 passes through the wavelength conversion device 5 causing substantially no energy loss due to excitation of the fluorophore. Then, as with the fluorescence Lf′ that has been scattered forward, the fluorescence Lb′ that has passed through the wavelength conversion device 5 is externally output from the light-source apparatus 1 along the optical axis X after being converted to collimated light at the second collimating optical system 6. By doing so, all of the fluorescence L′ generated at the wavelength conversion device 5 is output from the light-source apparatus 1 as the final output light.

In this case, the configuration of this embodiment is such that the optical path is linearly formed along the output optical axis X of the light source 2, and the fluorescence Lb′ that has been scattered backward is reflected by the single dichroic mirror 3, which is disposed so as to be perpendicular to the optical axis X, just once and in the direction parallel to the optical axis X. Therefore, shifts in the optical axis of the fluorescence Lb′ and energy loss of the fluorescence Lb′ are prevented, and the reflected fluorescence Lb′ is externally output from the light-source apparatus 1 along the optical axis X with sufficiently high efficiency. Accordingly, there is an advantage in that the fluorescence L′, serving as the output light, can be generated from the laser light L with high efficiency. In addition, by forming the optical path in a straight line, there is an advantage in that it is possible to make the optical-path configuration more compact.

Note that, in this embodiment, the single wavelength conversion device 5 is provided, and the green fluorescence L′ is generated from the blue laser light L; alternatively, however, a plurality of wavelength conversion devices 51 and 52 may be provided and light of plurality of colors may be generated from the blue laser light L.

A light-source apparatus 1 according to a modification shown in FIG. 2 is provided with two wavelength conversion devices 51 and 52 that are arrayed in the direction along the optical axis X. The first wavelength conversion device 51 has the same properties as the wavelength conversion device 5 described above. The second wavelength conversion device 52 contains a fluorophore whose excitation wavelength band includes 450 nm, which is the wavelength of the laser light L, and that generates fluorescence L″ having a longer wavelength than the fluorescence L′ generated at the first wavelength conversion device 51, for example, having a peak wavelength at 650 nm.

When the blue laser light L that has passed through the dichroic mirror 3 enters the first wavelength conversion device 51 and the second wavelength conversion device 52, the green fluorescence L′ is generated at the first wavelength conversion device 51, and the red fluorescence L″ is generated at the second wavelength conversion device 52. Of the green fluorescence L′ and the red fluorescence L″, fluorescence Lf′ and fluorescence Lf″ that have been scattered forward enter the second collimating optical system 6. On the other hand, fluorescence Lb′ and fluorescence Lb″ that have been scattered backward pass through the first collimating optical system 4, the first wavelength conversion device 51, and the second wavelength conversion device 52 after being reflected back by the dichroic mirror 3 and subsequently enter the second collimating optical system 6. Here, the respective light-emitting wavelength bands of the wavelength conversion devices 51 and 52 and the respective excitation wavelength bands of the wavelength conversion devices 51 and 52 overlap with each other only slightly or not at all. Therefore, the fluorescence Lb′ and the fluorescence Lb″ pass through the wavelength conversion devices 51 and 52 causing substantially no energy loss due to excitation of the fluorophores.

By doing so, from the monochromatic laser light L, it is possible to simultaneously generate light L′ and light L″ of two colors differing from that of the laser light L.

As shown in FIG. 3, the two wavelength conversion devices 51 and 52 may be arrayed in the direction that intersects the optical axis X. In this case, surfaces at which the two wavelength conversion devices 51 and 52 abut each other are placed substantially on the optical axis X so that the laser light L enters both wavelength conversion devices 51 and 52. In this way, too, as with the light-source apparatus 1, it is possible to simultaneously generate the green fluorescence L′ and the red fluorescence L″ from the blue laser light L.

In addition, in the configurations in which the plurality of wavelength conversion devices 51 and 52 are provided, as shown in FIGS. 2 and 3, it is not necessary that one of each of the wavelength conversion devices 51 and 52 be provided; for example, one first wavelength conversion device and two second wavelength conversion devices may be provided, or two of each of the first and second wavelength conversion devices may be provided.

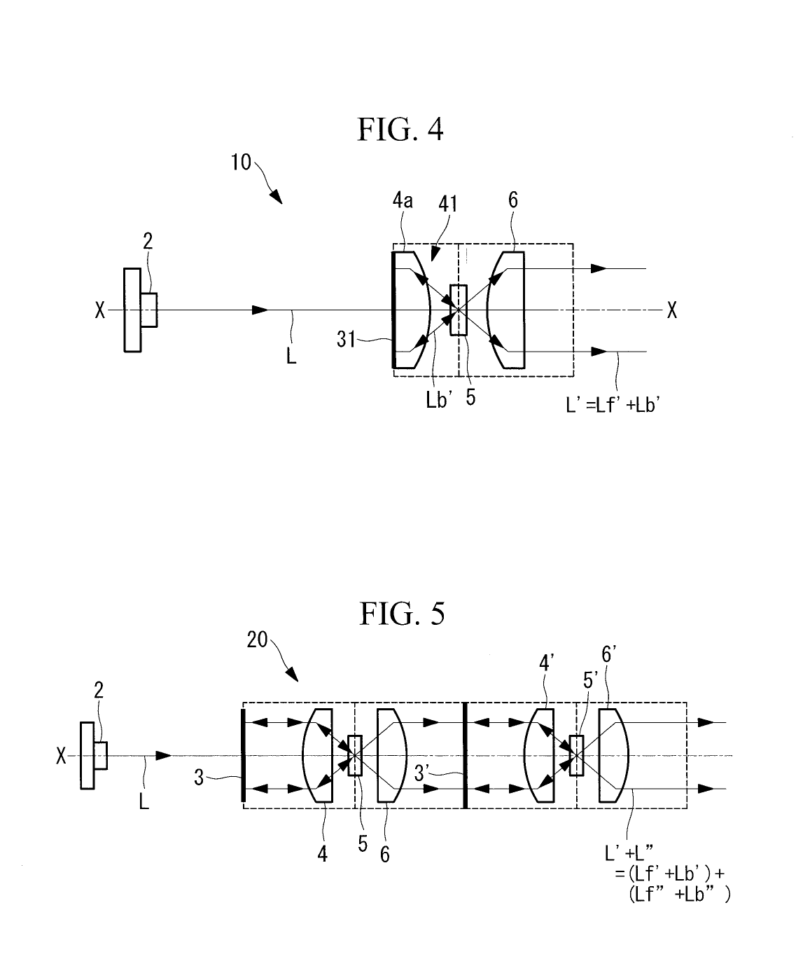

In addition, in this embodiment, the dichroic mirror 3 and the first collimating optical system 4 are formed as separate units; alternatively, however, as with a light-source apparatus 10 according to a modification shown in FIG. 4, the first collimating optical system 41 and the dichroic mirror 31 may be formed as a single unit. In this case, it is preferable that the first collimating optical system 41 be provided with a lens (a plano-convex lens in the illustrated example) 4a having a flat surface and that the dichroic mirror 31 be integrally formed at this flat surface of the lens 4a.

With the light-source apparatus 10 according to the thus-configured modification, it is possible to reduce the number of optical elements further and to make the optical-path configuration more compact. In this configuration also, the plurality of wavelength conversion devices 51 and 52, such as those shown in FIGS. 2 and 3, may be employed instead of the wavelength conversion device 5.

Here, among lens surfaces of lenses constituting the first collimating optical system 41, it is preferable that the lens surface that is placed closest to the light source 2 be flat and that the dichroic mirror 31 be formed at this flat surface. By doing so, the fluorescence Lb′ that has been scattered backward is made incident on the dichroic mirror 31 in a state in which it is satisfactorily converted to collimated light at the first collimating optical system 41, and thus, the efficiency of reflecting the fluorescence Lb′ by the dichroic mirror 31 can be enhanced.

In addition, in this embodiment, as in a light-source apparatus 20 according to a modification shown in FIG. 5, multiple sets (two sets in the illustrated example) of dichroic mirrors 3 and 3′, first collimating optical systems 4 and 4′, wavelength conversion devices 5 and 5′, and second collimating optical systems 6 and 6′ may be provided in series on the optical axis X.

In this case, as with the wavelength conversion device 52 in FIG. 2, the wavelength conversion device 5′ in the rear set generates fluorescence L″ having a longer wavelength (for example, fluorescence having the peak wavelength at 650 nm) than fluorescence L′ generated by the wavelength conversion device 5 in the front set. The dichroic mirror 3′ in the rear set has the property that it transmits the laser light L from the light source 2 and the fluorescence L′ generated by the wavelength conversion device 5 in the front set and reflects the fluorescence L″ generated by the wavelength conversion device 5′ in the rear set. Specifically, the plurality of wavelength conversion devices 5 and 5′ are configured so as to contain fluorophores that generate light whose wavelength band shifts toward the longer wavelengths with an increase in the distance from the light source 2 to the positions at which the wavelength conversion devices 5 and 5′ are disposed on the optical axis X, that is, as the wavelength conversion devices 5 and 5′ are disposed further toward the rear.

FIG. 9 shows the relationship assumed for the configuration of the light-source apparatus 20 among the wavelength of the laser light L, the wavelengths of the fluorescence L′ and the fluorescence L″ generated by the wavelength conversion devices 5 and 5′, and the spectral transmittance characteristics of the dichroic mirrors 3 and 3′. The left vertical axis indicates the transmittance of the dichroic mirrors 3 and 3′, and the right vertical axis indicates the relative intensity of the laser light L, the fluorescence L′, and the fluorescence L″.

In this way, the laser light L that has passed through the wavelength conversion device 5 in the front set excites the wavelength conversion device 5′ in the rear set to cause light emission.

With the light-source apparatus 20 according to this modification also, the plurality of wavelength conversion devices 51 and 52, such as those shown in FIGS. 2 and 3, may be employed instead of the wavelength conversion devices 5 and 5′.

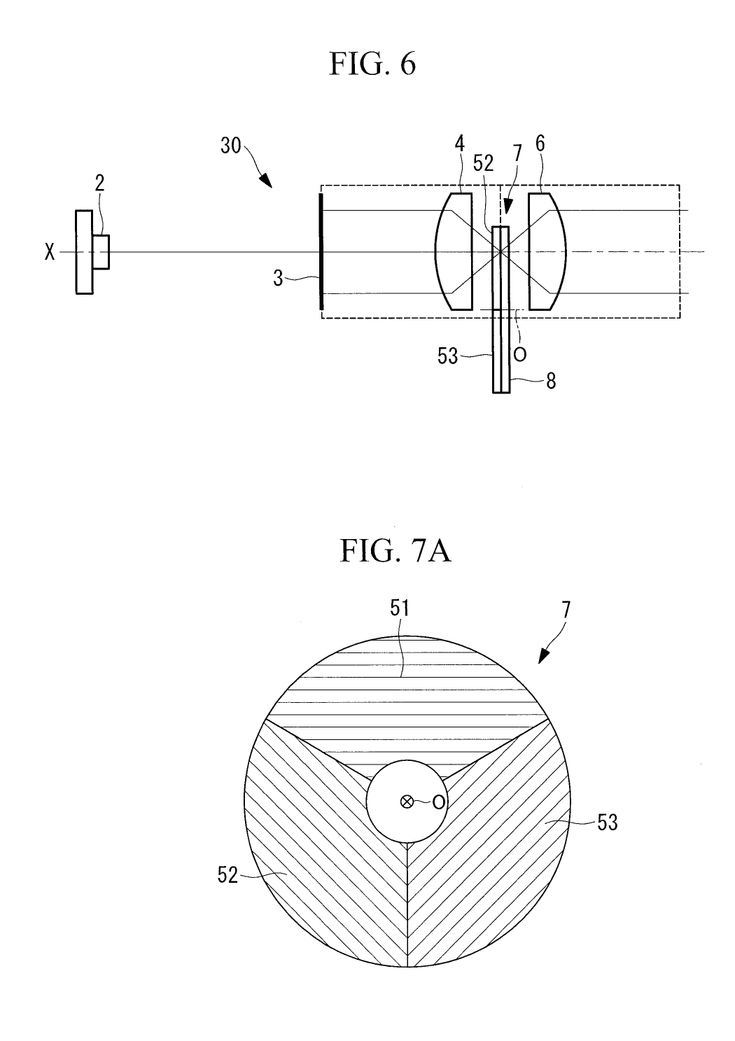

In addition, in this embodiment, the wavelength conversion device 5 is assumed to be fixedly placed in the optical path; alternatively, however, a plurality of wavelength conversion devices may be configured so as to be selectively placed in the optical path. For example, as shown in FIG. 6, a plurality of wavelength conversion devices 51, 52, and 53 may be provided in a rotating turret 7.

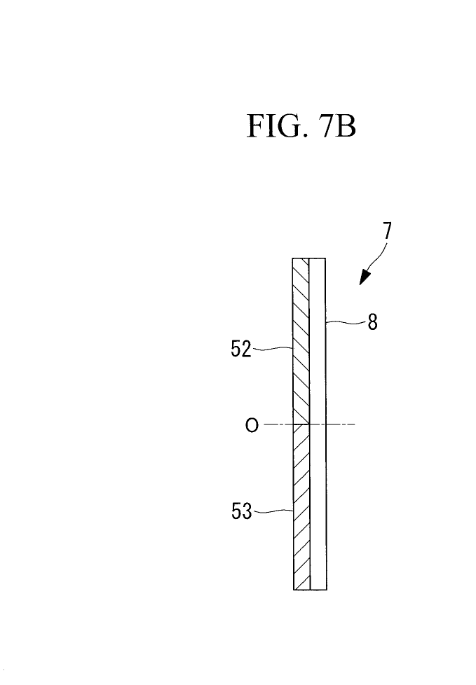

As shown in FIGS. 7A and 7B, the rotating turret 7 is provided with a diffuser plate 8 that transmits light and that spreads out the light, and a plurality of (three in the illustrated example) wavelength conversion devices 51, 52, and 53 that are provided in a circumferential direction at a surface of the diffuser plate 8 centered on a center axis O and that emit light having different colors from each other when irradiated with the laser light L. The rotating turret 7 is disposed in the optical path so that the center axis O is parallel to the optical axis X and is configured so that one of the wavelength conversion devices 51, 52, and 53 is placed in the optical path by being rotated about the center axis O by a driving mechanism (not shown).

With a light-source apparatus 30 according to the thus-configured modification, it is possible to change, in a simple manner, the color of final output light to be generated.

In addition, in this embodiment, although fluorophores and quantum dots have been described as examples of the light-emitter contained in the wavelength conversion device 5, examples of the wavelength conversion device 5 are not limited thereto.

In addition, in this embodiment, although the light-source apparatus 1 is provided with the collimating optical systems 4 and 6, the configuration of the light-source apparatus is not limited thereto, and a configuration provided with no collimating optical system may be employed.

### REFERENCE SIGNS LIST

1 light-source apparatus
2 light source
3 dichroic mirror
4 first collimating optical system
5 wavelength conversion device
6 second collimating optical system
L laser light (monochromatic light)
L′ fluorescence (light)
X output optical axis

1. A light-source apparatus comprising:
a light source that outputs monochromatic light;
a wavelength conversion device that is disposed on an output optical axis of the light source and that generates light having a different color from that of the monochromatic light upon being irradiated with the monochromatic light; and
a dichroic mirror that is disposed between the light source and the wavelength conversion device, that transmits the monochromatic light, and that, of the light generated at the wavelength conversion device, reflects back toward the wavelength conversion device light that has been scattered toward the light source so as to be parallel to the output optical axis.

2. The light-source apparatus according to claim 1, further comprising:
a first collimating optical system that is disposed between the dichroic mirror and the wavelength conversion device and that converts light that has been scattered from the wavelength conversion device toward the light source to collimated light; and
a second collimating optical system that is disposed at a rear stage of the wavelength conversion device and that converts light that has been scattered from the wavelength conversion device toward a side opposite the light source to collimated light.

3. The light-source apparatus according to claim 2,
wherein the first collimating optical system includes a lens having a flat surface, and
the dichroic mirror is integrally formed at the flat surface.

4. The light-source apparatus according to claim 2,
wherein the first collimating optical system is provided with a first lens, and
the first lens and the wavelength conversion device are disposed away from each other.

5. The light-source apparatus according to claim 2,
wherein the first collimating optical system is provided with a first lens, and
the first lens and the dichroic mirror are disposed away from each other.

6. The light-source apparatus according to claim 2,
wherein the second collimating optical system is provided with a second lens, and
the second lens and the wavelength conversion device are disposed away from each other.

7. The light-source apparatus according to claim 1, wherein a plurality of the wavelength conversion device are arrayed in a direction along the output optical axis or a direction that intersects the output optical axis in a region irradiated with the monochromatic light on the output optical axis.

8. The light-source apparatus according to claim 1, wherein a plurality of sets of the wavelength conversion device and the dichroic mirror are disposed in series on the output optical axis.

9. The light-source apparatus according to claim 3,
wherein the first collimating optical system is provided with a first lens, and
the first lens and the wavelength conversion device are disposed away from each other.

10. The light-source apparatus according to claim 3,
wherein the first collimating optical system is provided with a first lens, and
the first lens and the dichroic mirror are disposed away from each other.

11. The light-source apparatus according to claim 3,
wherein the second collimating optical system is provided with a second lens, and
the second lens and the wavelength conversion device are disposed away from each other.

12. The light-source apparatus according to claim 2, wherein a plurality of the wavelength conversion device are arrayed in a direction along the output optical axis or a direction that intersects the output optical axis in a region irradiated with the monochromatic light on the output optical axis.

13. The light-source apparatus according to claim 2, wherein a plurality of sets of the wavelength conversion device and the dichroic mirror are disposed in series on the output optical axis.
